(19) United States
(12) Patent Application Publication
(10) Pub. No.: US 2025/0362193 A1
(43) Pub. Date: Nov. 27, 2025

(54) SENSOR POSITIONING

(71) Applicant: EBM PAPST MULFINGEN GMBH & CO KG, Mulfingen (DE)

(72) Inventors: Andreas FESSEL, Weikersheim (DE); Simon HUTTER, Neuenstein (DE)

(21) Appl. No.: 19/217,139

(22) Filed: May 23, 2025

(30) Foreign Application Priority Data
May 27, 2024 (DE) 102024114838.1

(51) Int. Cl. G01L 13/02

(52) U.S. Cl. CPC G01L 13/025

(57) ABSTRACT

Sensor module 1 for differential pressure measurement in ventilation systems, in particular fans, by means of pressure determination, mass-flow determination or volume-flow determination, comprising: a processing unit 2, at least one pressure sensor 3, wherein the pressure sensor 3 is designed in such a way that it delivers to the processing unit 2 a signal corresponding to a local pressure 4 or volume flow 4 or mass flow 4, wherein the processing unit 2 comprises at least one interface 5 or is designed as an interface 5.

### CROSS-REFERENCE TO RELATED APPLICATION

This Application claims priority to German Application No. 10 2024 114 838.1, filed May 27, 2024; the contents of which is hereby incorporated by reference in their entirety.

### BRIEF DESCRIPTION OF THE DRAWINGS

FIG. 1 shows a schematic view of a sensor module, in one example.

FIG. 2 shows another schematic illustration of the sensor module, in one example.

### DETAILED DESCRIPTION

The present disclosure relates to the technical field of sensors for differential pressure measurements for pressure determination or mass-flow determination or volume-flow determination or pressure regulation or mass-flow regulation or volume-flow regulation in ventilation systems with the aid of fans having integrated commutation electronics.

Such devices and methods are already known.

For example, the document DE 10 2020 213 419 A1 discloses a fan for determining a media flow moved by the fan, comprising an electric motor and an impeller driven by the electric motor, wherein the impeller moves a gaseous medium in a media flow from an inflow side to an outflow side, wherein the media flow on the inflow side arrives at the impeller from an inflow chamber via an inflow nozzle. In this case, a pressure sensor system, a rotational speed determination system and an evaluation unit are provided, wherein the pressure sensor system is designed to determine an actual effective pressure of the inflow nozzle, wherein the rotational speed determination system is designed to determine an actual rotational speed of the impeller, and wherein the evaluation unit is designed to determine a mass flow and/or a conveyed volume flow of the medium on the basis of the actual effective pressure, the actual speed and at least one calibration variable that is dependent on the fan.

In addition, U.S. Pat. No. 11,754,083 B2 discloses a ventilator or fan consisting of: a motor, wherein the motor comprises: a control unit having integrated motor electronics; at least one sensor unit for pressure regulation or volume-flow regulation of at least one internal pressure tube inside the motor; and a passage, wherein the at least one sensor unit has a modular construction. In this case, the at least one sensor unit is configured such that it can be inserted into or onto a printed circuit board of the integrated motor electronics so that the at least one sensor unit is in contact with the printed circuit board of the integrated motor electronics. In this case, the at least one sensor unit contains a pressure sensor, wherein the pressure sensor is configured such that it determines the following:
(i) a local pressure across the at least one internal pressure tube or the at least one external pressure tube outside the motor; or
(ii) a pressure difference between a pressure at a first point in the at least one internal pressure tube or the at least one external pressure tube and a pressure at a second point in the at least one internal pressure tube or the at least one external pressure tube.

Furthermore, the pressure sensor of document U.S. Pat. No. 11,754,083 B2 is configured such that it delivers to a processing unit a signal corresponding to the local pressure or the pressure difference, wherein at least one internal pressure tube extends from the at least one sensor unit to the passage and from the passage to at least one connection for the at least one external pressure tube.

In summary, up to now, it is customary to install the pressure sensors directly on the printed circuit board of the integrated commutation electronics or to attach them to this printed circuit board in the form of a sensor module. Moreover, in the prior art, a sensor module is usually connected to a corresponding measuring point by means of pressure tubes.

However, the disadvantage in this case is that the effort required for attaching pressure tubes to pressure connectors of a pressure sensor located on or sensor module attached to a printed circuit board and the channeling thereof from the motor interior to the outside is considerable. Pressure tubes can bend, come loose, or present installation difficulties. For example, when miniature differential pressure sensors are used, the pressure tubes have to be securely mounted on connectors with a diameter of, for example, 2 mm and be attached to a connecting piece in order to be channeled to the connection connectors, this involving considerable effort.

A technical object of the present disclosure is therefore to improve the prior art and to enable a possibility for simplified attachment of the sensors.

All the features explained in connection with individual embodiments of the present disclosure can be provided in different combinations in the subject matter according to the present disclosure in order to realize their advantageous effect at the same time.

The scope of protection of the present invention is given by the claims and is not limited by the features explained in the description or shown in the figures.

In the context of the present disclosure, a fan is understood to mean a turbomachine which is driven by means of a motor, conveys a gaseous medium and for this purpose comprises an impeller which is flowed through axially or radially and which usually rotates in a housing, wherein a differential pressure is achieved between the intake side and the pressure side. In order to regulate a fan, knowledge of the differential pressure resulting in a particular operating state is relevant, for which pressures or a mass flow or a volume flow are respectively determined.

In the context of the present disclosure, a cable gland is understood to mean a cable entry, in particular in accordance with the EN 60423 standard, in the operation of a stuffing box, which has a particularly good seal of a cable, a wire or an insulated conductor during its passage through a housing wall, wherein it can also offer other functions such as, e.g., functional grounding, insulation, bend protection, strain relief or a combination of these.

Furthermore, in the context of the present disclosure, the terms pressure, volume flow and mass flow can be regarded as equivalent, which means that, for example, a pressure sensor can also be designed as a volume-flow sensor or as a mass-flow sensor.

According to one aspect, a technical object of the present disclosure is achieved by a sensor module for differential pressure measurement in ventilation systems, in particular fans, by means of pressure determination, mass-flow determination or volume-flow determination, comprising: a processing unit, at least one pressure sensor, wherein the pressure sensor is designed in such a way that it delivers to the processing unit a signal corresponding to the local pressure or volume flow or mass flow, wherein the processing unit comprises at least one interface or is designed as an interface.

It is advantageous in this case that connection of the sensor module to a measuring point, instead of being done, for example, by means of pressure tubes as is otherwise customary in the prior art, is replaced by the use of an interface and the connection is thus simplified. The sensor module can thus move physically closer to the measuring point and be integrated into existing housing components, such as, for example, terminal-box housings, in a space-saving manner.

In one technically advantageous embodiment, provision is made for the interface to be designed to transmit the signal of the pressure sensor to motor electronics, in particular to motor electronics of a ventilation system, preferably to motor electronics of a fan.

Advantageously, a digital or analog transmission or an electronic connection between the interface and the motor electronics can be produced, this sparing further components. It is thus possible to save parts and components and a more cost-effective production can thus be made possible.

In another technically advantageous embodiment, provision is made for the interface to be designed as an analog interface, in particular as a 0-10 V voltage interface, or as a digital interface, in particular as a digital interface in accordance with the industry standard EIA-485, preferably as an inter-integrated circuit interface.

Existing and established standards can thus advantageously be used and a simple electronic connection can be made possible.

Moreover, in one technically advantageous embodiment, provision is made for the sensor module to be designed as an insert of a cable gland, wherein the insert is formed in particular by means of a pressure-stable sleeve, preferably in combination with a potting compound, wherein the cable gland is formed in particular in two parts, wherein the cable gland preferably comprises at least a gland outer part and a gland inner part.

Quick and easy assembly and cost-effective production can thus advantageously be made possible. In addition, additionally existing and established components and part standards can advantageously be used.

In addition, in one technically advantageous embodiment, provision is made for the sensor module to comprise at least a first pressure-measuring connector and a second pressure-measuring connector, wherein, in particular, the pressure-measuring connectors are connected to a corresponding first sensor connector of the pressure sensor and a corresponding second sensor connector of the pressure sensor by means of a bushing, in particular by means of a bushing of a cable gland.

More flexible and process-safe installation possibilities can thus advantageously be created and the corresponding measurements can be optimized.

Furthermore, in one technically advantageous embodiment, provision is made for the sensor module to be designed such that it is able to be fastened, in particular able to be screwed, onto or into a housing wall, in particular onto or into a housing wall of the fan, in particular onto or into a housing wall of a motor of the fan, preferably onto or into the housing wall of a terminal box that is to be fastened to a motor.

The integration and installation can thus be advantageously improved and already existing components, in particular housing components, can be advantageously used for this purpose.

In addition, in one technically advantageous embodiment, provision can be made for the pressure sensor to be designed in such a way that it detects a local pressure or volume flow or mass flow at at least a first sensor connector, in particular at a first pressure-measuring connector, or at at least a second sensor connector, in particular at a second pressure-measuring connector.

Moreover, in one advantageous embodiment, provision is made for the pressure sensor to be designed in such a way that it detects a pressure difference between a pressure at a first sensor connector, in particular a first pressure-measuring connector, and a pressure at a second sensor connector, in particular at a second pressure-measuring connector.

The flexibility when using the sensor module can thus be advantageously improved and the possibilities for measurement can be adapted to meet corresponding requirements.

Furthermore, in one technically advantageous embodiment, provision is made for at least a first sensor connector to be connected to a first pressure-measuring connector by means of a first pressure tube, in particular across a bushing, and/or for at least a second sensor connector to be connected to a second pressure-measuring connector by means of a second pressure tube, in particular across a bushing.

Advantageously, this can additionally improve the integration and installation and enable cost-effective production.

According to a further aspect, a technical object of the present disclosure is achieved by a ventilation system, in particular fan, comprising a motor, a motor housing, a motor control unit having integrated motor electronics, at least one sensor module, wherein the sensor module is designed for pressure regulation or volume-flow regulation or mass-flow regulation of the motor, wherein the motor in particular comprises integrated commutation electronics, wherein the sensor module is designed according to one of the preceding claims.

The advantages already mentioned can thus be advantageously applied in a ventilation system, such as, for example, in a fan.

Furthermore, in one technically advantageous embodiment, provision is made for the sensor module and/or the interface to receive a power supply from the motor electronics.

Additional components, such as further supply lines or supply systems, can be advantageously saved and a simpler and more cost-effective production can be made possible.

In addition, in one technically advantageous embodiment, provision is made for the interface to be connected to the motor electronics by means of a conductor, in particular by means of an electrical connection.

Advantageously, this can also additionally increase the technical flexibility.

Exemplary embodiments are illustrated in the figures and are described in more detail below.

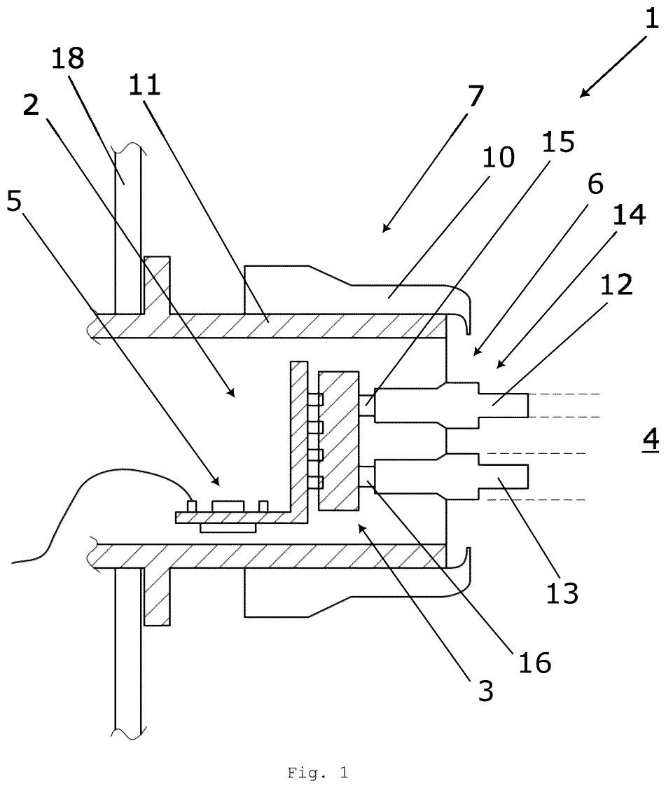

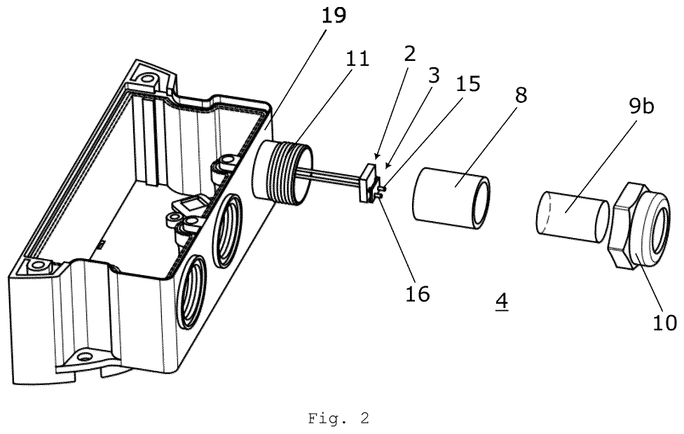

In an overview of FIG. 1 and FIG. 2, a schematic view of a sensor module 1 for differential pressure measurement in ventilation systems by means of pressure determination, mass-flow determination or volume-flow determination is illustrated in each case. This sensor module 1 comprises: a processing unit 2, a pressure sensor 3, wherein the pressure sensor 3 is designed in such a way that it delivers to the processing unit 2 a signal corresponding to the local pressure or volume flow or mass flow 4, wherein the processing unit 2 comprises at least one interface 5 or is designed as an interface 5.

In an overview of FIG. 1 and FIG. 2, it is illustrated that the connection of the sensor module 1 to the measuring point is realized by means of an interface 5. The interface 5 is designed to transmit the signal of the pressure sensor 3 to motor electronics.

Furthermore, in an overview of FIG. 1 and FIG. 2, the following is illustrated: In this case, the sensor module 1 is designed as an insert 6 of a cable gland 7, wherein the insert 6 is formed by means of a pressure-stable sleeve 8, in combination with a potting compound 9.

The cable gland 7 is formed in two parts and comprises a gland outer part 10 and a gland inner part 11. As a result, the sensor module 1 is designed such that it is able to be screwed to a housing wall 18 of a terminal box that is to be fastened, for example, to a motor. In this case, the sensor module 1 comprises a first pressure-measuring connector 12 and a second pressure-measuring connector 13, wherein the pressure-measuring connectors 12, 13 are connected to a corresponding first sensor connector 15 of the pressure sensor 3 and a corresponding second sensor connector 16 of the pressure sensor 3 by means of a bushing 14 of a cable gland 7.

The pressure sensor 3 is designed to detect a local pressure 4 or volume flow 4 or mass flow 4 at the first sensor connector 15 or the second sensor connector 16, or to detect a pressure difference between the pressure 4 at the first pressure-measuring connector 12 and the pressure 4 at the second pressure-measuring connector 13.

Furthermore, the figures illustrate that the sensor module 1 and/or the interface 5 receive a power supply which is located remotely and can be provided, for example, by motor electronics which are not illustrated. In this case, the interface 5 is connected to the motor electronics by means of an electrical connection, for digital or analog signal transmission or for electronic connection and/or for power supply.

This can advantageously simplify and improve the installation. The sensor module 1 thus moves physically closer to the measuring point of the local pressure 4 or the volume flow 4 or the mass flow 4 and can be integrated in existing housing components, such as, for example, terminal box housings or in a housing wall 18, in a space-saving manner.

Although the present invention has been described with reference to preferred embodiments, workers skilled in the art will recognize that changes may be made in form and detail without departing from the spirit and scope of the invention.

### LIST OF REFERENCE SIGNS

1 sensor module
2 processing unit
3 pressure sensor
4 local pressure or volume flow or mass flow
5 interface
6 insert
7 cable gland
8 pressure-stable sleeve
9 potting compound

10 gland outer part
11 gland inner part
12 first pressure-measuring connector
13 second pressure-measuring connector
14 bushing
15 first sensor connector
16 second sensor connector
18 housing wall
19 terminal box

1. A sensor module for differential pressure measurement in a ventilation system by at least one of pressure determination, mass-flow determination, or volume-flow determination, the sensor module comprising:
a processing unit, and
at least one pressure sensor,
wherein the at least one pressure sensor is configured to deliver, to the processing unit, a signal corresponding to at least one of a local pressure, a volume flow, or a mass flow,
wherein the processing unit comprises at least one interface, and
wherein the sensor module is designed as an insert of a cable gland.

2. The sensor module according to claim 1, characterized wherein the at least one interface is designed to transmit the signal of the at least one pressure sensor to motor electronics.

3. The sensor module according to claim 1, wherein the at least one interface is designed as an analog interface or as a digital interface.

4. The sensor module according to one of the preceding claim 1, wherein the insert is formed by a pressure-stable sleeve.

5. The sensor module according claim 1, wherein the sensor module comprises at least a first pressure-measuring connector and a second pressure-measuring connector.

6. The sensor module according to claim 1, wherein the sensor module is configured to fasten onto or into a housing wall.

7. The sensor module according to claim 1, wherein the pressure sensor is configured to detect at least one of a local pressure, a volume flow, or a mass flow at at least a first sensor connector or at at least a second sensor connector.

8. The sensor module according to claim 1, wherein the pressure sensor is configured to detect a pressure difference between at least one of a local pressure, a volume flow, or a mass flow at a first sensor connector, and at least one of a local pressure a volume flow, or a mass flow at a second sensor connector.

9. The sensor module according to claim 1, wherein at least a first sensor connector is connected to a first pressure-measuring connector by a first pressure tube and/or at least a second sensor connector is connected to a second pressure-measuring connector by a second pressure tube.

10. A ventilation system, comprising
a motor,
a motor housing,
a motor control unit having integrated motor electronics, and
at least one sensor module designed for at least one of pressure regulation, volume-flow regulation, or mass-flow regulation of the motor, wherein the at least one sensor module comprises:
a processing unit, and
at least one pressure sensor,
wherein the at least one pressure sensor is configured to deliver, to the processing unit, a signal corresponding to at least one of a local pressure, a volume flow, or a mass flow, and
wherein the processing unit comprises at least one interface.

11. The ventilation system according to claim 10, wherein the at least one sensor module and/or the at least one interface receive a power supply from the integrated motor electronics.

12. The ventilation system according to claim 11, wherein the at least one interface is connected to the integrated motor electronics by a conductor.

13. The ventilation system according to claim 10, wherein the ventilation system comprises at least one fan.

14. The sensor module according to claim 1, wherein the ventilation system comprises at least one fan.

15. The sensor module according to claim 2, wherein the motor electronics comprise motor electronics of the ventilation system.

16. The sensor module according to claim 3, wherein the at least one interface comprises at least one of:
a 0-10 voltage (V) analog interface, or
a digital interface in accordance with the industry standard EIA-485.

17. The sensor module according to claim 4, wherein the insert is formed by the pressure-stable sleeve in combination with a potting compound, wherein the cable gland is formed in two parts comprising at least a gland outer part and a gland inner part.

18. The sensor module according to claim 5, wherein the first and second pressure-measuring connectors are connected to a corresponding first sensor connector of the at least one pressure sensor and a corresponding second sensor connector of the at least one pressure sensor by a bushing.

19. The sensor module according to claim 6, wherein the housing wall comprises a housing wall of a fan.

20. The sensor module according to claim 7, wherein the at least one pressure sensor is configured to detect the at least one of a local pressure, a volume flow, or a mass flow at a first pressure-measuring connector or a second sensor connector.
